(19) United States
(12) Patent Application Publication
(10) Pub. No.: US 2024/0005689 A1
(43) Pub. Date: Jan. 4, 2024

(54) Efficient use of training data in data capture for Commercial Documents

(71) Applicant: David Pintsov, San Diego, CA (US)

(72) Inventor: David Pintsov, San Diego, CA (US)

(21) Appl. No.: 17/855,225

(22) Filed: Jun. 30, 2022

(51) Int. Cl. G06V 30/414; G06V 30/19; G06V 30/18; G06V 30/412

(52) U.S. Cl. CPC G06V 30/414; G06V 30/19147; G06V 30/18143; G06V 30/412

(57) ABSTRACT

An automated method for capturing data from electronic images of commercial documents such as invoices, bills of lading, explanations of benefits, etc. is described. An optimal mapping between the fields of interest in an image of a page of a document and the corresponding fields of a pre-trained image of a page of a similar document is defined. This mapping allows an automatic precise extraction of data from the fields of interest in an image regardless of distortions the image is subjected to in the process of scanning.

### FIELD OF INVENTION

The present invention describes a method and system for an automatic capture of data of interest from a plurality of electronic documents (e.g. in TIFF, PDF or JPG formats) once a single example of a document from the same source and layout with known field positions and data is available. The source of electronic documents could be accounting systems, enterprise resource management software, accounts receivable management software, etc.

### BACKGROUND OF THE INVENTION AND RELATED ART

The number of documents that are exchanged between different businesses is increasing very rapidly. Every institution, be it a commercial company, an educational establishment or a government organization receives hundreds and thousands of documents from other organizations every day. All these documents have to be processed as fast as possible and information contained in them is vital for various functions of both receiving and sending organizations. It is, therefore, highly desirable to automate the processing of received documents. Typically, commercial documents such as invoices, purchase orders, bills of lading and others are created by a software program that specifies a layout of information on each page of the document so that the document contains permanent information such legends/keywords designating the data fields (e.g. Invoice Number, Bill Number, Carrier Name, etc.) and variable information (an actual invoice number, a specific carrier name) that needs to be captured from these documents. The salient feature of the document creating software is that mutual relations between the permanent information and the variable information for each originating system rarely, if at all, changes. In other words, the layout of the documents from individual sources rarely changes and if, for instances, the “ship to” address is placed underneath the “ship to” legend for one instance of the bill of lading from a given source it stays in the same relative position for another instance of the bill. Of course, there are thousands and thousands different layouts produced by individual originating entities.

The references described below and the art cited in those references is incorporated in the background of the present invention. There are many data capture systems known in the art. There are commercially available systems from companies such Kofax, ABBYY, AnyDoc, and many others. U.S. Pat. No. 8,660,294 B2 describes the typical data capture methods deployed by these companies.

Briefly, the method comprises two parts, the setup for each individual layout and the actual data capture utilizing a normally laborious setup. The setup process consists of a usually highly qualified technician or a programmer who creates a detailed formalized description of the mutual relations between permanent and variable elements of each individual layout either within a specially created user interface or actually using a programming language to create a program encoding these relations. The disadvantages of such methods are well known and described in U.S. Pat. No. 8,660,294 B2, the chief one being a high labor intensity that is coupled with difficulty maintaining the systems that utilize them. U.S. Pat. No. 8,660,294 B2 therefore discloses a method that utilizes data entered by an operator from an instance of a document, that data being locations of the fields of interest in the image that instance of the document. It also describes the use of keywords (in itself a well-known mechanism universally utilized) such as “Total” by instructing the system to find the data of interest “to the right of the printed word ‘Total’ on the physical form”. The main recipe in U.S. Pat. No. 8,660,294 B2 prescribes finding in the new incoming image the words closest to the words already found by the operator in an instance (template) of the document of the same origin as the incoming image.

There are potential problems that limit the efficiency of these methods: the keywords such as “Total” could be corrupted or obscured by some obstacles such as preprinted lines or by the noise introduced by the scanning process and with the manifold of words found in images the words closest to a known location maybe not the words sought. FIG. 2 shows two sets of words (shown as their bounding rectangles) on two images of the same origin and illustrates a combinatorial difficulty of finding the closest words when the incoming image is sufficiently displaced relative to the template. The arrows indicate a desired correspondence between the fields of the two images. Thus, it is desirable to find an efficient method that would accomplish capturing the data of interest on the basis of data from an already learned image. Methods of finding this learned/trained image were disclosed U.S. Pat. No. 8,831,361 B2 and U.S. Pat. No. 10,607,115 B1.

### SUMMARY OF THE INVENTION

The present invention provides a method and system for automatically finding and capturing data in electronic images of documents having a specific fixed originating mechanism such as computer printing program. This is accomplished with the help of a known example of a document originating from the same source. It is assumed that in accordance with the previously disclosed art this example is completely known with all the words in it and their positions and attributes such as their lengths in characters.

### BRIEF DESCRIPTION OF THE DRAWINGS

FIG. 1 is an illustrative representation of a typical class of documents that are subject of the present invention.

FIG. 2 depicts two sets of words designated by their bounding rectangles found on two documents from the same source together with the arrows showing a desired correspondence between the words in two documents.

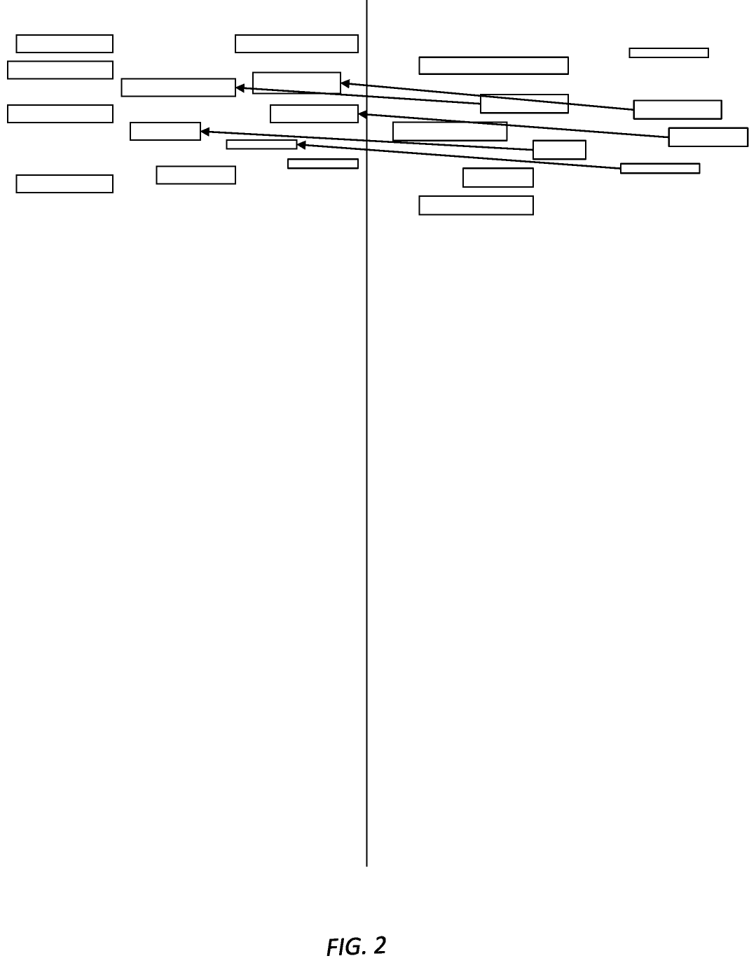

FIG. 3 depicts a geometric distance between words

FIG. 4 shows the flowchart of data capture for any two images.

### DETAILED DESCRIPTION OF THE PREFERRED EMBODIMENT

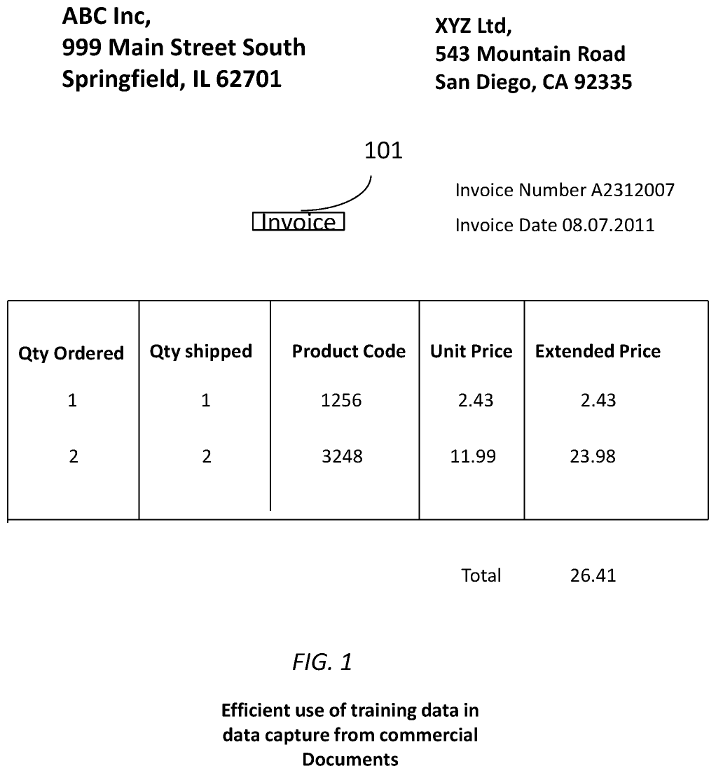

In what follows the system operates with two images from the same source: the image I from which the data has to be captured and the image T on which the system has been trained and learned all the data of interest. FIG. 1, depicts a typical business document, where element 101 shows a word. Some of the words represent permanent content (such as legends, e.g. “P.O. Number”) and some words represent variable content such a specific instance of a P.O. Number. For example, Fannie Mae 1003 form printed in the same year by the same company would normally possess preprinted permanent legends such as the words “Borrower” and “Co-Borrower” and horizontal lines such as those framing the words “TYPE OF MORTGAGE and TERMS OF LOAN”. On the other hand, the actual names and addresses on the documents would constitute variable elements. The documents originating from different organizations would normally have totally different layouts. Similarly, the patterns of pre-printed horizontal and vertical geometric lines L that are distinguished by their positions and lengths exhibit a degree of invariance provided that they originate with the same source. This does not mean that the lines would be identical since the documents having variable contents necessitate variability in the line patterns. Even invoices printed by the same software program may have a different number of line items, different number of columns and different number of lines. The main problem one is facing trying to locate the data of interest while armed with an example of such data is that the images coming from the same source could be shifted both horizontally and vertically relative to each other. Typically, with the modern scanners the horizontal shift is less pronounced than the vertical shift but both could present a serious problem. The legends (such as “Borrower” or “Total”) are either known beforehand on account of their general use for a class of documents of known exactly from the specific learned example of a document.

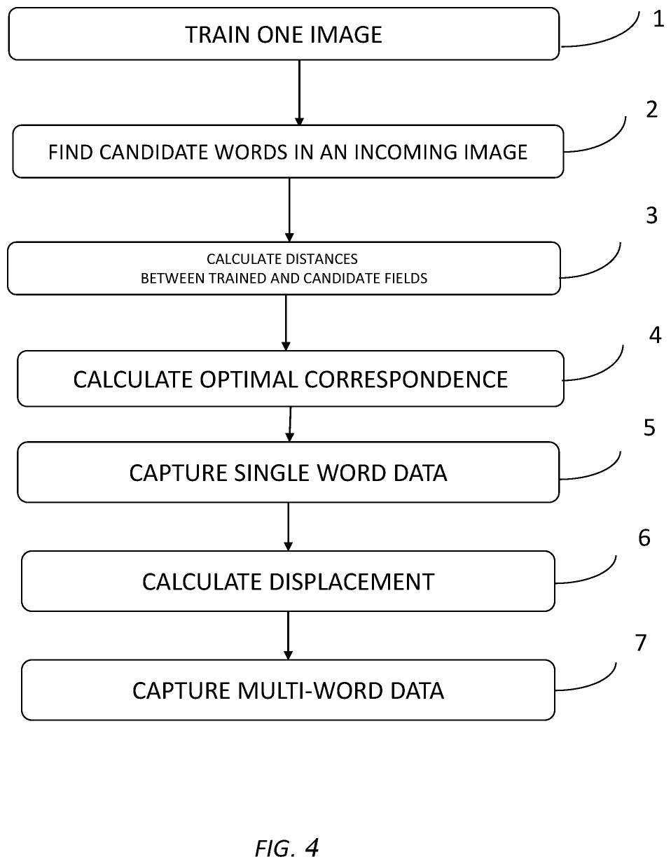

The first step according to the preferred embodiment of the present invention is for any image I of a page of the document to find all the words in that image with all their bounding rectangles and their OCR identities (FIG. 4, step 1). This is routinely done by any commercially available OCR software. The words in the known/learned example of the document are known with all their attributes, that is their bounding rectangles, their exact content (either via OCR or via operator corrections) and their characteristic of either being permanent (that is a legend, a keyword such as “invoice number”) or variable such as the actual content of the field “Invoice Number” (e.g. 576003). Normally, the fields of interest are single word fields, and they will be addressed first. The next step according to the present invention is for each captured field/word W in the learned image T to introduce its own distance to be used against all the candidate words in the other image where the fields are to be captured. For each such word W the distance to each candidate word w is calculated as a combination of distances—the geometric distance and the attribute distance as detailed below. The geometric distance between W and w is calculated as

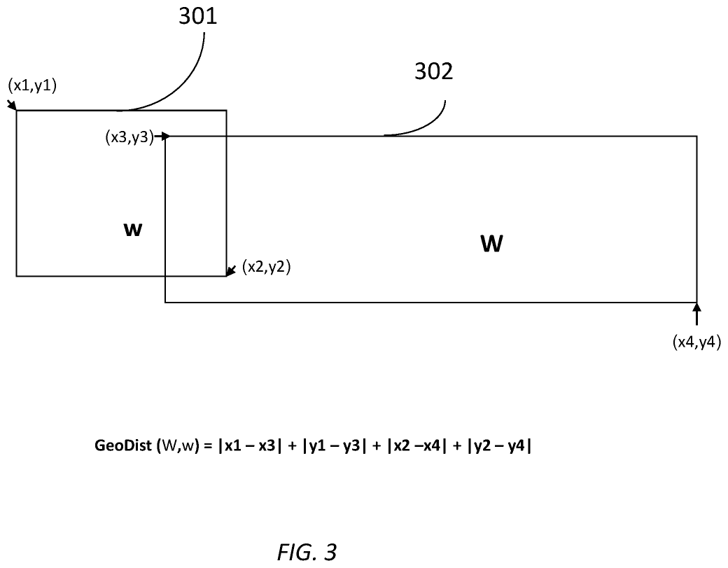

GeoDist(W,w)=|x1−x3|+|y1−y3|+|x2−x4|+|y2−y4|,

where (x₁, y₁) and (x₂, y₂) are the Cartesian coordinates of the left upper corner and the right lower corner of word W and (x₃, y₃) and (x₄, y₄) are the corresponding coordinates of corners of word w. (FIG. 3, where elements 301 and 302 represent w and W respectively) There may be other ways to measure a geometric distance between words and those skilled in art can modify the method that is described in the present invention in any manner without detracting from the essence of the present invention. The second component of the distance between W and w is what can be called an attribute distance, and it is calculated in the following manner. The length and the character composition of W is known so that W can be represented by a string such as L=aapnnnnnnnn or L=apnpannnnn or any combination of alpha, numeric and punctuation characters, where a is an alpha character, n is a digit and p is a punctuation character (that is known from the learned image, typically a hyphen). If the candidate word w from image I is represented by its own character string C (say nnnnnnnpnn) then the string distance StringDist (L, C) can be calculated between L and C according to a well known Damerau-Levenshtein distance algorithm (Levenshtein V. I., “Binary codes capable of correcting deletions, insertions, and reversals”. Soviet Physics Doklady 10: pp. 707-710, 1966) or any other string distance method such as, the Fisher-Wagner dynamic programming algorithm as described in R. A. Wagner and M. J. Fisher, The string-to-string correction problem, Journal of the Association for Computing Machinery, 21(1):168-173, January 1974. U.S. Pat. No. 8,831,361 describes string matching which is incorporated as a reference herein for convenience. The only difference with the standard string distance here is that the alphabet of symbols used in the calculation is reduced to exactly three: a, n and p. If W is a legend (e.g. “Total”), that is a part of the permanent layout, the standard string distance is used, that is the one that utilizes the whole alphabet. If a legend consists of two or more words separated by a space, such as “Invoice Number” they can be found separately and then combined into one string relative to which the actual content of the field is located. Armed with GeoDist and StringDist it is now possible to calculate

WordDistance(W,w)=u GeoDist(W,w)+v StringDist(W,w),

for each W and for each candidate word w, where u and v are appropriate weights. So, if there are k fields/words W captured in image T, k different distances are used.

Once the distance between W and w has been defined, a matrix of pair-wise distances WordDistance (W,w) is obtained for pairs of words (W,w) in two images I and T. The preferred embodiment for the present invention utilizes assignment algorithms that calculate the optimal correspondence/mapping of words (W,w) (matching in the sense of the shortest distance) based on the distance described above. Assignment algorithms are described in R. Burkard, M. Dell'Amico, S. Martello, Assignment Problems, SIAM, 2009, and incorporated by reference herein. The net result of this mapping is the captured set of fields in image I, as the desired subset X of words w that is in the one-to-one correspondence with the words W<->X.

If the same two permanent legends K and k can be found automatically and correlated in images I and T (such as unique words “Invoice Number” in both of them) then in another embodiment of the present invention it may be sufficient to calculate displacements of all the words W relative to K and apply the same displacements to find words X relative to legend k. It is not always possible to find permanent legends in images since they can be printed in a very noisy fashion or negatively or obscured by lines or other obstacles. However, the images I and T are most frequently shifted as a whole relative to one another providing largely the same displacement of fields of interest in two images. This circumstance also allows an independent verification of the results of the assignment method described above. The assignment algorithm runs in strongly polynomial time, thus making it an efficient method of using learning for data capture. If the displacement can be estimated from K and k only the words w having approximately the same displacement would participate in the calculations.

A modification of this method would utilize the same word distance as defined above but with the standard string (edit) distance between the legends K and k to arrive at the optimal correspondence of legends even if some of them are corrupted or only partially recognizable. This optimal correspondence of legends immediately allows the calculation of the displacement vector s between the images I and T, since all the legends and the corresponding fields are typically shifted in unison barring more severe non-linear distortions that are rarely observed outside of fax images. In essence, this is a process of an automatic registration of images. If the scanning process is sufficiently accurate only vertical and horizontal shifts will be present so that the application of the displacement vector s is sufficient. If skew or more severe affine distortions are present this method applied to three or more legends will provide the parameters of the full affine transformation that converts the coordinates of the fields in image I to the coordinates of corresponding fields in image T. The application of the assignment algorithm with WordDistance as defined above to all the pairs of training image fields of interest and all the candidate words in image I transformed via displacement vector s (or affine transformed if need be) will result in capturing of all the fields of interest in the image I.

Some fields of interest are multi-word fields such as addresses. The coordinates and extents of such fields are precisely known in the image T. Typically, the printing program allocates a fixed amount of real estate to each address. Once the correspondence of single word fields has been established it is possible to calculate the displacement of all multi-word fields in I relative to corresponding fields in the image T and thus capture them accurately (FIG. 4, steps 6 and 7).

All geometrical lines are known in the training image T including those that potentially border the fields of interest in images. The lines in the image I corresponding to the lines in the image T could be used to provide the positions of fields in the image I. Horizontal and vertical geometric line distances and optimal correspondence of these lines in two images were defined in U.S. Pat. No. 8,831,361 B2 which is incorporated as a reference herein. While there are several ways to define distances between geometric lines any good distance will provide a suitable measure of proximity between lines. In images with close layouts the corresponding distances between the lines bordering fields in the images I and T are designed to be the same and therefore the knowledge of these distances in T provides the knowledge of the corresponding distances in I thus providing the positions of sought fields. Namely, a distance between a horizontal line and a word can be defined as a vertical distance between the left upper corner of the bounding box of the word and the ordinate of the horizontal line. Similarly, a distance between a vertical line and a word can be defined as a horizontal distance between the left upper corner of the bounding box of the word and the abscissa of the vertical line. Measuring these distances in the image T provides estimates of the corresponding distances in the image I.

What is claimed is:

1. A method of automatic data capture from commercial documents such as invoices, with an input image and a training image originating from the same source, the values and locations of fields of interest are known for said training image and using a computer performing the steps of:
automatically obtaining the salient features of the training document image, said features consisting of words, their lengths, their constituent characters, and positions of geometric lines in the training document image, said lines being horizontal and vertical;
automatically obtaining said features in the input document image;
calculating the optimal correspondence between lines in the training image and the input image, said lines being horizontal and vertical;
defining and calculating distances between horizontal and vertical lines and fields of interest in the training image and using these distances to calculate the positions of the fields of interest in the input image;
defining and calculating combinations of geometric and string distances between words of the training image and the input image;
automatically mapping the words and fields of the training image into words and fields of the input image, providing an optimal assignment of these words and fields;
automatically capturing the words of interest in input images;
and automatically capturing the single word fields of interest in the input image.

2. A method according to claim 1 of automatic data capture for multi-word fields according to which the coordinates of multi-word fields in an image are calculated using computer performing the steps of:
Computing the coordinates of single word fields in the image by using corresponding coordinates of the single word fields in the training image;
Computing the displacement of the input image relative to the training image;
Applying said displacement to the coordinates of multi-word fields in the training image to obtain the coordinates of the multi-word fields in the input image.

3. (canceled)
